(19) United States
(12) Patent Application Publication
(10) Pub. No.: US 2023/0199532 A1
(43) Pub. Date: Jun. 22, 2023

(54) MOBILE TERMINAL TEST DEVICE AND PARAMETER SETTING METHOD THEREOF

(71) Applicant: ANRITSU CORPORATION, Kanagawa (JP)

(72) Inventors: Daisuke NAKAGAWA, Kanagawa (JP); Daiki KANO, Kanagawa (JP); Takumi NAKAMURA, Kanagawa (JP); Atsuki MORITA, Kanagawa (JP); Masahiro ARAYAMA, Kanagawa (JP)

(21) Appl. No.: 18/055,468

(22) Filed: Nov. 15, 2022

(30) Foreign Application Priority Data
Dec. 20, 2021 (JP) 2021-205771

(51) Int. Cl. H04W 24/06; H04W 72/04

(52) U.S. Cl. CPC H04W 24/06; H04W 72/0453

(57) ABSTRACT

To provide a mobile terminal test device capable of efficiently performing a test by facilitating switching of parameter settings when switching a simulated base station. The mobile terminal test device includes a control unit 6 that, when a test is performed by simulating a plurality of base stations, retains a parameter common to the plurality of simulated base stations and a parameter individual for each of the plurality of simulated base stations, as the parameters for simulating the base stations, and sets the parameter common to the simulated base stations as it is, and switches and sets the parameter individual for each of the simulated base stations.

### TECHNICAL FIELD

The present invention relates to a mobile terminal test device that tests a mobile terminal.

### BACKGROUND ART

When a mobile terminal such as a portable phone or a data communication terminal that performs communication while moving has been developed, it is necessary to test whether or not the developed mobile terminal can perform communication normally. Therefore, a test in which a mobile terminal under test is connected to a test device that operates as a simulated base station that simulates the functions of an actual base station, communication is performed between the test device and the mobile terminal, and the content of the communication is checked is performed.

In addition, in a mobile communication system, a service of 5th Generation (5G) New Radio (NR), which is a 5G radio scheme, has started.

The frequency bands used in 5G NR are broadly classified into two frequency ranges of FR1 (Frequency Range 1): 450 to 6,000 MHz and FR2 (Frequency Range 2): 24,250 to 52,600 MHz.

Patent Document 1 discloses that a frequency range and the like are set as parameters in a mobile terminal test device that simulates a 5G NR base station.

### RELATED ART DOCUMENT

### Patent Document

[Patent Document 1] JP-A-2021-121085

### DISCLOSURE OF THE INVENTION

### Problem That the Invention is to Solve

However, in such a mobile terminal test device, when measurement conditions with different frequency ranges are set, it is necessary to change many parameters. Therefore, it takes a long time to perform a call connection test by switching the frequency range.

An object of the present invention is to provide a mobile terminal test device capable of efficiently performing a test by facilitating the switching of parameter settings when switching between simulated base stations.

### Means for Solving the Problem

According to the present invention, a mobile terminal test device tests a mobile terminal by simulating a base station in a mobile communication. The mobile terminal test device includes a control unit that, when the test is performed by simulating a plurality of base stations, retains a parameter common to the plurality of simulated base stations and a parameter individual for each of the plurality of simulated base stations, as the parameters for simulating the base stations, and sets the parameter common to the simulated base stations as it is, and switches and sets the parameter individual for each of the simulated base stations.

With this configuration, the parameter common to the plurality of simulated base stations and the parameter individual for each of the plurality of simulated base stations are retained. In addition, the parameter common to the simulated base stations are set as it is, and the parameter individual for each of the simulated base stations is switched and set. Therefore, it is possible to switch parameter setting easily and in a short time by setting all parameters each time the simulated base station is switched.

In the mobile terminal test device according to the present invention, the mobile terminal test device is configured to enable a test of the mobile terminal compatible with 5G NR. The control unit retains the parameter common to the base stations having the different frequency ranges and the parameter individual for each frequency range, when a test is performed by simulating base stations having different frequency ranges of 5G NR, and sets the parameter common to the frequency ranges as it is, and switches and sets the parameter individual for each of the frequency ranges when an instruction to switch the frequency range is issued by a user.

With this configuration, the parameter common to the base stations having different frequency ranges and the parameter individual for each frequency range are retained. When an instruction to switch the frequency range is issued by a user, the parameter common to the frequency ranges is set as it is, and the parameter individual for each frequency range is switched and set. Therefore, it is possible to switch parameter setting easily and in a short time by setting all parameters each time the frequency range is switched.

Further, in the mobile terminal test device according to the present invention, one of the base stations having different frequency ranges is compatible to Frequency Range 1 of 450 to 6000 MHz, and the other is compatible to Frequency Range 2 of 24250 to 52600 MHz.

According to the present invention, there is provided a parameter setting method of a mobile terminal test device that tests a mobile terminal by simulating a base station in a mobile communication. The parameter setting method includes a step of retaining a parameter common to a plurality of simulated base stations and a parameter individual for each of a plurality of simulated base stations, as the parameters for simulating the base stations when the test is performed by simulating a plurality of base stations, and a step of setting the parameter common to the simulated base stations as it is, and switching and setting the parameter individual for each of the simulated base stations in response to an instruction of a user.

With this configuration, the parameter common to the plurality of simulated base stations and the parameter individual for each of the plurality of simulated base stations are retained. In addition, in response to an instruction of a user, the parameter common to the simulated base stations are set as it is, and the parameter individual for each of the simulated base stations is switched and set. Therefore, it is possible to switch parameter setting easily and in a short time by setting all parameters each time the simulated base station is switched.

### Advantage of the Invention

According to the present invention, it is possible to provide a mobile terminal test device capable of efficiently performing a test by facilitating the switching of parameter settings when switching between simulated base stations.

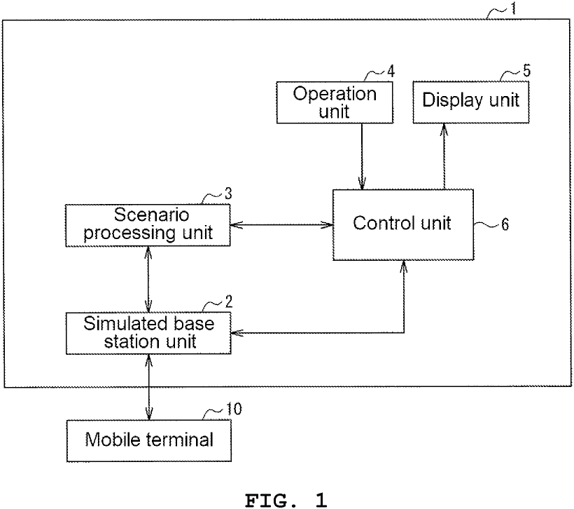

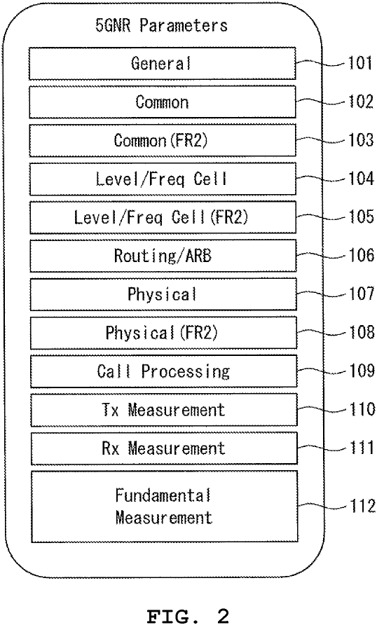

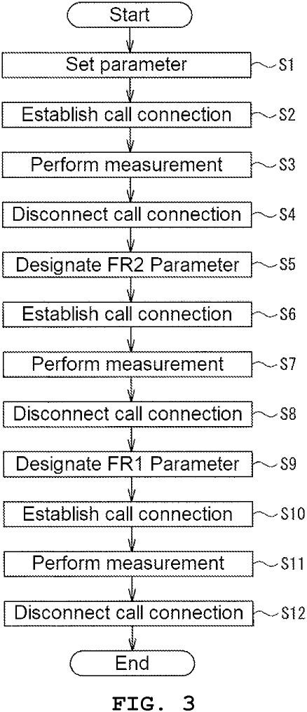

### BRIEF DESCRIPTION OF THE DRAWINGS

[FIG. 1] FIG. 1 is a block diagram illustrating main units of a mobile terminal test device according to an embodiment of the present invention.

[FIG. 2] FIG. 2 is a diagram illustrating an example of a method of retaining a parameter in the mobile terminal test device according to the embodiment of the present invention.

[FIG. 3] FIG. 3 is a flowchart for explaining a procedure of frequency range switching test processing of the mobile terminal test device according to the embodiment of the present invention.

### BEST MODE FOR CARRYING OUT THE INVENTION

Hereinafter, a mobile terminal test device according to an embodiment of the present invention will be described in detail with reference to the drawings.

In FIG. 1, a mobile terminal test device 1 according to an embodiment of the present invention acts as a simulated base station to transmit and receive an RF (radio frequency) signal to and from a mobile terminal 10 via a coaxial cable or the like in a wired manner. The mobile terminal test device 1 may wirelessly transmit and receive an RF signal to and from the mobile terminal 10 via an antenna.

The mobile terminal test device 1 is configured to include a simulated base station unit 2, a scenario processing unit 3, an operation unit 4, a display unit 5, and a control unit 6.

The simulated base station unit 2 transmits and receives an RF signal to and from the mobile terminal 10 under the control of the scenario processing unit 3. The simulated base station unit 2 outputs the state of the communication with the mobile terminal 10 and the like to the control unit 6.

The simulated base station unit 2 can perform 5G NR communication with the mobile terminal 10 in accordance with the 5G NR standard.

In response to an instruction from the control unit 6, the scenario processing unit 3 reads out a stored scenario and causes the simulated base station unit 2 to transmit notification information or execute a communication sequence with the mobile terminal 10, based on the scenario.

The operation unit 4 is configured by an input device such as a keyboard, a mouse, and a touch panel, and outputs information and the like that are input by an operation and are required for generating the scenario, to the control unit 6. The display unit 5 is configured by an image display device such as a liquid crystal display, and displays an image for inputting information required for generating a scenario, an image indicating a state during a test, and the like.

In accordance with an instruction input to the operation unit 4, the control unit 6 causes the display unit 5 to display a test scenario creation screen to input information required for generating the test scenario, or to generate the test scenario based on the information input to the operation unit 4 on the test scenario creation screen. In addition, in accordance with an instruction input to the operation unit 4, the control unit 6 transmits the instruction to the scenario processing unit 3 to perform a test based on a test scenario stored in a storage device or to display the state or the like during the test on the display unit 5 based on information on the state of each layer and the state of communication with the mobile terminal 10, which are transmitted from the scenario processing unit 3, and the like.

Here, the mobile terminal test device 1 is configured by a computer device (not illustrated) provided with a communication module for communicating with the mobile terminal 10. The computer device includes a central processing unit (CPU), a read only memory (ROM), a random access memory (RAM) , a storage device such as a hard disk device, an input and output port, and a touch panel (not illustrated).

A program for causing the computer device to function as the mobile terminal test device 1 is stored in the ROM and the hard disk device of the computer device. That is, the computer device functions as the mobile terminal test device 1 by the CPU executing the program stored in the ROM by using the RAM as a work area.

As described above, in the present embodiment, the scenario processing unit 3 and the control unit 6 are configured by the CPU, and the simulated base station unit 2 is configured by the communication module.

In the mobile terminal test device 1 having such a configuration, when testing the mobile terminal 10 compatible with 5G NR, the control unit 6 causes the user to set a parameter as the simulated 5G NR base station, a test signal sequence, and the like. Then, the control unit 6 creates a test scenario and stores the test scenario in the storage device.

The mobile terminal test device 1 in the embodiment can easily switch the setting of frequency ranges of FR1 and FR2.

For example, when a frequency range switching parameter is set to ON, the control unit 6 enables parameter setting for each frequency range.

For example, the control unit 6 sets a parameter commonly between by frequency ranges and a parameter used for each frequency range.

The control unit 6 uses, as the parameter commonly used between the frequency range, for example, “Ran Operation” for setting an operation mode of the Radio Access Network, setting of call control, and “FR1+FR2 Measurement Mode” for designating a frequency range as a target of transmission measurement.

The control unit 6 sets, for example, parameters as follows, as the parameter used for each frequency range: “Duplex Mode” for setting a Duplex Mode of TDD or FDD; “Frequency Range” for setting the frequency range of the selected cell; “ULSubcarrier Spacing” for setting the transmission numerology (Subcarrier Spacing) of an Uplink; “DL Subcarrier Spacing” for setting the transmission numerology (Subcarrier Spacing) of a Downlink; “UL Channel Bandwidth” for setting a channel bandwidth of an Uplink; “DL Channel Bandwidth” for setting a channel bandwidth of a Downlink; “UL Antenna Configuration” for setting an antenna configuration of an Uplink; “DL Antenna Configuration” for setting an antenna configuration of a Downlink; “UL Center Frequency” for setting an Uplink center frequency; “DL Center Frequency” for setting a Downlink center frequency; “UL Center Channel” for setting the center channel of an Uplink; “DL Center Channel” for setting the center channel of a Downlink; “Input Level” for setting an input level of a component carrier (CC) in an Uplink in carrier aggregation; and “Output Level” for setting an output level of a CC in a Downlink in carrier aggregation.

The control unit 6 stores the set parameters in the storage device, for example, as illustrated in FIG. 2. In FIG. 2, the control unit 6 sets the parameter commonly used between the frequency ranges in a General unit 101, a Routing/ARB unit 106, a Call Processing unit 109, a Tx Measurement unit 110, an Rx Measurement unit 111, and a Fundamental Measurement unit 112. The control unit 6 sets the parameter individual for FR1 in a Common unit 102, a Level/Freq Cell unit 104, and a Physical unit 107. In addition, the control unit 6 sets the parameter individual for FR2 in a Common (FR2) unit 103, a Level/Freq Cell (FR2) unit 105, and a Physical (FR2) unit 108.

For example, when an instruction to switch the frequency range is issued in response to an operation of the operation unit 4 by the user, the control unit 6 performs reference switching between the parameters of the Common unit 102, the Level/Freq Cell unit 104, and the Physical unit 107, and the parameters of the Common (FR2) unit 103, the Level/Freq Cell (FR2) unit 105, and the Physical (FR2) unit 108.

The frequency range switching test processing by the mobile terminal test device according to the present embodiment, which is configured as described above, will be described with reference to FIG. 3. The frequency range switching test processing described below is started when an instruction to start the test is issued in response to an operation of the operation unit 4 by the user.

In Step S1, the control unit 6 sets parameters for FR1 and FR2. After executing the process of Step S1, the control unit 6 executes the process of Step S2.

In Step S2, the control unit 6 establishes a call connection with the mobile terminal 10. After executing the process of Step S2, the control unit 6 executes the process of Step S3.

In Step S3, the control unit 6 measures an RF signal from the mobile terminal 10 by executing a call control sequence. After executing the process of Step S3, the control unit 6 executes the process of Step S4.

In Step S4, the control unit 6 disconnects the call with the mobile terminal 10 after the predetermined measurement is ended. After executing the process of Step S4, the control unit 6 executes the process of Step S5.

In Step S5, when, in response to the operation of the operation unit 4 by the user, an instruction to switch the frequency range is issued, and the parameters of FR2 are designated, the control unit 6 switches the parameters of the Common (FR2) unit 103, the Level/Freq Cell (FR2) unit 105, and the Physical (FR2) unit 108. After executing the process of Step S5, the control unit 6 executes the process of Step S6.

In Step S6, the control unit 6 establishes a call connection with the mobile terminal 10. After executing the process of Step S6, the control unit 6 executes the process of Step S7.

In Step S7, the control unit 6 measures an RF signal from the mobile terminal 10 by executing a call control sequence. After executing the process of Step S7, the control unit 6 executes the process of Step S8.

In Step S8, the control unit 6 disconnects the call with the mobile terminal 10 after the predetermined measurement is ended. After executing the process of Step S8, the control unit 6 executes the process of Step S9.

In Step S9, when, in response to the operation of the operation unit 4 by the user, an instruction to switch the frequency range is issued, and the parameters of FR1 are designated, the control unit 6 switches the references to the parameters of the Common unit 102, the Level/Freq Cell unit 104, and the Physical unit 107. After executing the process of Step S9, the control unit 6 executes the process of Step S10.

In Step S10, the control unit 6 establishes a call connection with the mobile terminal 10. After executing the process of Step S10, the control unit 6 executes the process of Step S11.

In Step S11, the control unit 6 measures an RF signal from the mobile terminal 10 by executing a call control sequence. After executing the process of Step S11, the control unit 6 executes the process of Step S12.

In Step S12, the control unit 6 disconnects the call with the mobile terminal 10 after the predetermined measurement is ended. After executing the process of Step S12, the control unit 6 ends the frequency range switching test processing.

As described above, in the above-described embodiment, the control unit 6 retains the parameter common to the frequency ranges and the parameter individual for each frequency range. In addition, in response to the instruction of the user, the control unit 6 sets the common parameter as it is, and switches and sets the parameter individual for each frequency range.

As a result, it is possible to switch parameter setting easily and in a short time in comparison to a case of setting all the parameters each time the frequency range is changed.

In the present embodiment, the case of switching the frequency range has been described. The parameter setting can be performed in a similar manner, in a case where a plurality of base stations are simulated, and a parameter common to the plurality of simulated base stations and a parameter individual for each of the plurality of simulated base stations are provided.

Hitherto, the embodiment of the present invention has been disclosed, but it is clear that changes can be made by those skilled in the art without departing from the scope of the present invention. All such modifications and equivalents are intended to be included in the claims as follows.

DESCRIPTION OF REFERENCE NUMERALS AND SIGNS

| | |
|---|---|
| 1 | MOBILE TERMINAL TEST DEVICE |
| 2 | SIMULATED BASE STATION UNIT |
| 3 | SCENARIO PROCESSING UNIT |
| 4 | OPERATION UNIT |
| 5 | DISPLAY UNIT |
| 6 | CONTROL UNIT |
| 10 | MOBILE TERMINAL |

What is claimed is:

1. A mobile terminal test device that tests a mobile terminal by simulating a base station in a mobile communication, the device comprising:
a control unit that, when a test is performed by simulating a plurality of the base stations,
retains a parameter common to the plurality of simulated base stations and a parameter individual for each of the plurality of simulated base stations, as the parameters for simulating the base stations, and
sets the parameter common to the simulated base stations as it is, and switches and sets the parameter individual for each of the simulated base stations.

2. The mobile terminal test device according to claim 1, wherein
the mobile terminal test device is configured to enable the test of the mobile terminal compatible with 5G NR, and
the control unit
retains the parameter common to the base stations having different frequency ranges and the parameter individual for each of the frequency ranges, when the test is performed by simulating base stations having the different frequency ranges of 5G NR, and
sets the parameter common to the frequency ranges as it is, and switches and sets the parameter individual for each of the frequency ranges when an instruction to switch the frequency range is issued by a user.

3. The mobile terminal test device according to claim 2, wherein
one of the base stations having the different frequency ranges is compatible with Frequency Range 1 of 450 to 6000 MHz, and
the other is compatible with Frequency Range 2 of 24250 to 52600 MHz.

4. A parameter setting method of a mobile terminal test device that tests a mobile terminal by simulating a base station in a mobile communication, the method comprising: when a test is performed by simulating a plurality of the base stations,
a step of retaining a parameter common to the plurality of simulated base stations and a parameter individual for each of the plurality of simulated base stations, as the parameters for simulating the base stations; and
a step of setting the parameter common to the simulated base stations as it is, and switching and setting the parameter individual for each of the simulated base stations in response to an instruction of a user.
